(19) United States
(12) Patent Application Publication
(10) Pub. No.: US 2012/0117258 A1
(43) Pub. Date: May 10, 2012

(54) TECHNIQUES TO DEPLOY AND UNDEPLOY CONTENT TO AND FROM WEB SERVERS

(75) Inventor: Darin Spivey, Boca Raton, FL (US)

(73) Assignee: CBS INTERACTIVE INC., San Francisco, CA (US)

(21) Appl. No.: 12/942,220

(22) Filed: Nov. 9, 2010

(51) Int. Cl. G06F 15/16

(52) U.S. Cl. 709/229

(57) ABSTRACT

Techniques to deploy and undeploy content to and from web servers are described. In some embodiments, a method to deploy content to a web server may include selecting multiple files to deploy to one or more web servers, selecting one or more destinations for the one or more multiple files, copying one or more existing files from the one or more web servers to be replaced by the multiple files, creating a backup batch using the one or more existing files and publishing the multiple files to the one or more web servers. Other embodiments are described and claimed.

### BACKGROUND

Web design is a practice of creating presentations of content that are delivered to an end-user through a medium such as the World Wide Web, using a Web browser or other Web-enabled software to render a website. The content contained on websites is becoming increasingly dynamic, with some sites including content that is updated or changed on a frequent basis. Deploying content such as data and images is one important aspect of maintaining a dynamic website. When deploying and undeploying content, it is advantageous to track what content is being deployed. It may also be advantageous to track what user is deploying and undeploying content and limit the capacity of some users to interact with certain content. As a result, it is desirable to enhance the dynamic deployment and undeployment of content. For example, it may be advantageous to create a tool that is operative to allow users to upload content, edit content, view content and source content prior to deployment or to undeploy content. Consequently, there exists a substantial need for techniques to improve dynamic deployment and undeployment of content to and from web servers. It is with respect to these and other considerations that the present improvements have been needed.

### BRIEF DESCRIPTION OF THE DRAWINGS

FIG. 1 illustrates an embodiment of a first system.

FIG. 2 illustrates an embodiment of a user interface.

FIG. 3 illustrates an embodiment of a logic flow.

FIG. 4 illustrates an embodiment of a computing architecture.

FIG. 5 illustrates an embodiment of a communications architecture.

### DETAILED DESCRIPTION

Various embodiments are directed to techniques to deploy and undeploy content to and from web servers. In some embodiments, for example, a computer-implemented method to deploy content to a web server may comprise selecting multiple files to deploy to one or more web servers, selecting one or more destinations for the one or more multiple files, copying one or more existing files from the one or more web servers to be replaced by the multiple files, creating a backup batch using the one or more existing files and publishing the multiple files to the one or more web servers. In some embodiments, a tool to efficiently deploy and undeploy content to and from web servers may be described. The tool or method may provide a means to get content on a website that is used by a code base. The tool may serve as an interface for users to push content out to production servers, for example. In some embodiments, the content may include, but is not limited to, data files, image files, .dat files, .html files or any other files or data that are used to render pages of a website. Other embodiments are described and claimed.

Basic deployment of content to web servers is not a new concept. Tools exist to allow users to select files to be uploaded to production servers. These tools, however, generally do not present an easy to use user interface, or provide other robust features such as undeploy capabilities, user authentication or the ability to upload, view, source and edit files using the tool. Additionally, current tools for deploying content do not maintain a complete history of all the files a user has deployed and provide the ability to undeploy or redeploy any of those files, which may be maintained in batches allowing for easy handling of files in an efficient bulk manner. These and other features are described in the following techniques, methods, articles and apparatus. As a result, the described embodiments can improve the dynamic deployment, undeployment or redeployment of content for an operator, device or network.

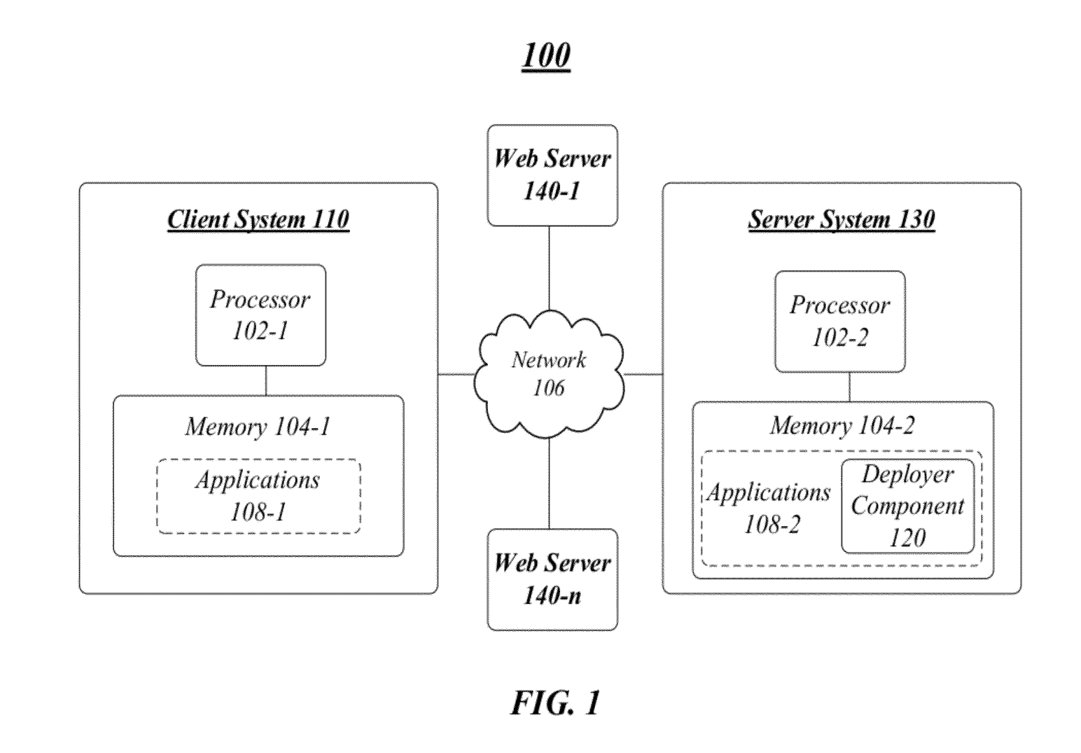

FIG. 1 illustrates a block diagram for a system 100 to deploy and undeploy content. In one embodiment, for example, the system 100 may comprise a computer-implemented system 100 having multiple components 110, 130 and 140-1-n. As used herein the terms “system” and “component” are intended to refer to a computer-related entity, comprising either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In the illustrated embodiment shown in FIG. 1, the system 100 may be implemented as part of an electronic device. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. Although the system 100 as shown in FIG. 1 has a limited number of elements in a certain topology, it may be appreciated that the system 100 may include more or less elements in alternate topologies as desired for a given implementation.

The components 110, 130 and 140-1-n may be communicatively coupled via various types of communications media. The components 110, 130 and 140-1-n may coordinate operations between each other. The coordination may involve the uni-directional or bi-directional exchange of information. For instance, the components 110, 130 and 140-1-n may communicate information in the form of signals communicated over network 106. The information can be implemented as signals allocated to various signal lines or signals transmitted using any suitable signaling protocol. Other embodiments are described and claimed.

System 100 may comprise a distributed system in some embodiments. The distributed system 100 may distribute portions of the structure and/or operations for the system across multiple computing entities. Examples of distributed system 100 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, for example, the distributed system 100 may be implemented as a client-server system. A client 110 may be implemented as or comprise a user device, such as a personal computer, that may include one or more applications 108-1. A server 130 may comprise a web server or other suitable device and may implement deployer component 120. Web servers 140-1-n may comprise production servers arranged to push content out to a user base via one or more websites. The client 110 and the servers 130 and 140-1-n may communicate with each over a network 106. In one embodiment, for example, the network 106 may comprise a wireless local area network (WLAN) or any other suitable computer network.

In various embodiments, the servers 130 and 140-1-n may comprise or employ one or more server computing devices and/or server programs that operate to perform various methodologies in accordance with the described embodiments. For example, when installed and/or deployed, a server program may support one or more server roles of the server computing device for providing certain services and features.

Exemplary servers 130 and 140-1-n may include, for example, stand-alone and enterprise-class server computers operating a server OS such as a MICROSOFT® OS, a UNIX® OS, a LINUX® OS, or other suitable server-based OS. Exemplary server programs may include, for example, communications server programs such as Microsoft® Office Communications Server (OCS) for managing incoming and outgoing messages, messaging server programs such as Microsoft® Exchange Server for providing unified messaging (UM) for e-mail, voicemail, VoIP, instant messaging (IM), group IM, enhanced presence, and audio-video conferencing, and/or other types of programs, applications, or services in accordance with the described embodiments.

In various embodiments, client system 110 and server system 130 may include, without limitation processors 102-1 and 102-2, memory 104-1 and 104-2 and applications 108-1 and 108-2. While not shown in FIG. 1, web servers 140-1-n may include the same or similar components to server system 130. In some embodiments, server system 130 may additionally include deployer component 120. Deployer component 120 may comprise one of applications 108-2 in some embodiments. In various embodiments, a component such as deployer component 120 may comprise hardware, software or any combination of hardware and software and still fall within the described embodiments. While deployer component 120 is shown as part of server system 130 in FIG. 1, it should be understood that deployer component 120 could be included anywhere in system 100 and still fall within the described embodiments. For example, deployer component 120 could be implemented on client system 100 in some embodiments. Other embodiments are described and claimed.

Processors 108-1 and 108-2 may comprise or include any type of processing unit, such as, for example, CPU, multi-core processor, multi-processing unit, a reduced instruction set computer (RISC), a processor that has a pipeline, a complex instruction set computer (CISC), digital signal processor (DSP), and so forth. In some embodiments, processors 102-1 and 102-2 may comprise or include logical and/or virtual processor cores. Each logical processor core may include one or more virtual processor cores in some embodiments. For example, each processor 102-1 and 102-2 may comprise a multi-core processor having two virtual cores resulting in a total of eight available cores for multi-core processors 102-1 and 102-2. The embodiments are not limited in this respect and other embodiments are described and claimed.

In various embodiments, memory 104-1 and 104-2 may comprise any suitable type of memory unit, memory device, memory article, memory medium, storage device, storage article, storage medium and/or storage unit, for example, memory, removable or non-removable media, volatile or non-volatile memory or media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like.

Applications 108-1 and 108-2 may comprise any application, logic, module or set of computer instructions suitable for execution by client system 110 or server system 130 in some embodiments. For example, applications 108-1 and 108-2 may include, without limitation, an operating system (OS), e-mail application, web browsing application, word processing application, media application, an so forth. While a limited number and type of applications are described for purposes of clarity, it should be understood that any suitable application could be used and still fall within the described embodiments.

In various embodiments, deployer component 120 may comprise one of applications 108-2. While deployer component 120 is shown as an application 108-2 contained in memory 104-2 for purposes of illustration, it should be understood that deployer component 120 could be located anywhere in system 100 and still fall within the described embodiments. For example, deployer component need not be contained within memory 104-2. Deployer component 120 may provide or comprise a deployer application or tool in some embodiments. For example, deployer component 120, when executed by processor 102-2, may be operative to deploy and undeploy multiple files to and from web servers 140-1-n. In some embodiments, the multiple files are stored as batches and backups of each batch are stored on one or more servers, such as server 130 for example.

In various embodiments, the deployer component may be programmed in accordance with various programming languages, application platforms and application frameworks, including JAVA made by Oracle Corporation, COLDFUSION made by Adobe Systems, .NET made by Microsoft® Corporation, WebORB for .NET, Hypertext Preprocessor (PHP), Ruby, Python, Perl, Lisp, Dylan, Pike, Cluster (CLU), Smalltalk, Eiffel, Ruby on Rails (RoR), C, C++, C#, and so forth. The logic 120 may also comprise part of a RIA, such as a front-end of a SOA for deployment on a web browser of a client computing device using various client side technologies, such as an Adobe Flash platform programmed in an object-oriented programming language such as ACTIONSCRIPT™ and ADOBE® FLEX, made by Adobe Systems Incorporated. It may be appreciated that these programming languages are provided by way of example and not limitation. Deployer component 120 may be implemented using any suitable programming language.

Deployer component 120 may be operative to allow a user to select multiple files to deploy to the one or more web servers in some embodiments. For example, a user of client system 110 may access deployer component 120 and may select multiple files to be deployed to web servers 140-1-n. A user may select the multiple files from one or more of the memory of the apparatus or a storage medium on a remote device, for example. In some embodiments, content may be selected from client device 110 or content may be selected that is already residing on one or more of servers 130 and 140-1-n. For example, selecting multiple files may comprise selecting new content to be deployed or selecting existing content to be redeployed. In either case, a user can navigate to the correct location where the files should reside, then either upload new content for that location or select content that is already there to be redeployed or modified then deployed. In various embodiments, when files are uploaded or selected, they go into a users' current batch that may comprise a temporary staging location for the files that is private and unique for each individual user. By grouping the files in these private batches, users may be able to work on different versions of the same files without the risk of interfering with other users.

In some embodiments, when a user selects a file to deploy or uploads one, the file is copied into their private workspace, leaving the original file untouched until a new version is deployed. Users can modify existing files or add new files to their batch in this way. Files in each batch can be viewed, sourced, or downloaded for modification. In various embodiments, the files in the current batch are placed in a location that reflects where they currently are in a file navigator. The current batch may comprise a new batch using the multiple selected files in some embodiments.

A user may select one or more destinations for the one or more multiple files in some embodiments. In various embodiments, the one or more destinations may comprise different destinations for one or more of the multiple files. For example, a user may select a number of files stored in memory 104-1 to be deployed to web servers 140-1-n. In some embodiments, one or more of the files may be destined for web server 140-1 and one or more of the remaining files may be destined for any other web server 140-n. The files may all be destined for the same location in some embodiments. The embodiments are limited in this context.

In various embodiments, deployer component 120 may be operative to copy one or more existing files from the one or more web servers to be replaced by the multiple files. For example, a backup batch may be created using the one or more existing files. In some embodiments, deployer component 120 may be operative to copy each file that is to be replaced by the selected files in the current or new batch. By doing so, deployer component 120 may ensure that changes made when the new batch is deployed can quickly and easily be undone in the event that a mistake is made or the new batch deployment was otherwise improper or incorrect.

The new batch and the backup batch may be saved on one or more servers in some embodiments. For example, the batches may be saved on server 130 in some embodiments. By saving the batches on a server, rather than a local machine of a user, a secure and reliable backup of each batch is created. By saving each batch, in some embodiments, a history of all files and batches deployed to the one or more web servers can be maintained.

In some embodiments, the multiple files of the new batch may be published to the one or more web servers, overwriting the existing files. For example, a user may select the files for deployment and then deploy the multiple files to the selected locations. The locations may already contain content that will be overwritten by the new content included in the multiple files. In various embodiments, the content being overwritten is saved as a backup batch for later recovery. Other embodiments are described and claimed.

The deployer component 120 may be operative to undeploy the multiple files in some embodiments. For example, the deployer component 120 may be operative to pull back previously deployed files in any number of batches. In various embodiments, the undeploying comprises redeploying the one or more existing files from the backup batch to overwrite multiple files that were subsequently deployed. In this manner, users do not need to search for and locate each file in a batch to roll back changes. Instead, entire batches can be deployed or undeployed together, increasing the efficiency of web content development and deployment and simplifying the user experience.

In some embodiments the deployer component 120 may be operative to receive or require user authentication prior to uploading, viewing, editing or publishing the multiple files. For example, an administrator or other party may provide a user with log in credentials, and each set of log in credentials may be unique and specific to a particular user or group of users. By requiring user authentication to interact with the deployer component 120 and further to deploy or undeploy content, administrators can effectively control who is allowed to interact with selected content. In various embodiments, the deployer component 120 may be operative to allow possession or overriding control over another user using administrating authentication to upload, view, edit or publish files from one or more batches created by the other user. For example, an administrator may possess a users account to make changes to a batch that otherwise would be only available to the user. The embodiments are not limited in this respect.

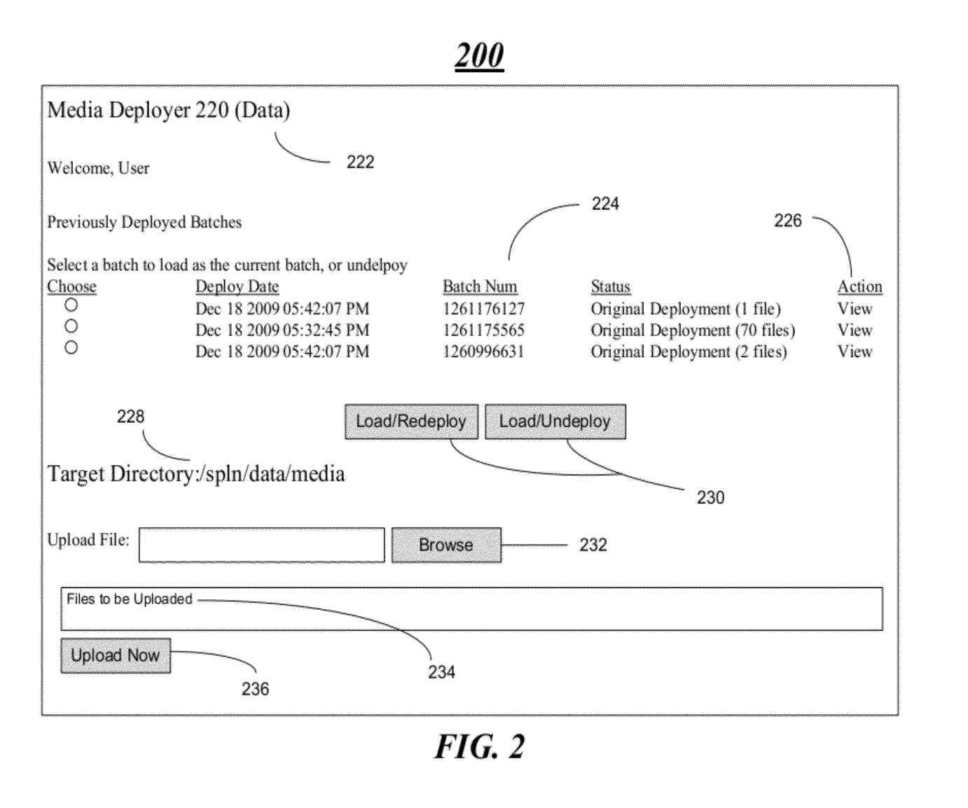

FIG. 2 illustrates one embodiment of a user interface 200. In various embodiments, user interface 200 may comprise an interface created to allow a user to interact with a deployer program or logic, such as deployer component 120 of FIG. 1. As shown in FIG. 2, user interface 200 may include any number or arrangement of data, information, buttons, fields, toggles, radio buttons, links or any other information or interactive entity suitable for enhancing the deployer tool.

In various embodiments, the user interface 200 may include a toggle link 222 that may be operative to allow a user to switch between different tree structure views. The user interface may also include a list or other view 224 of batches that are currently available in the batch manager. An action column 226 may be included in some embodiments illustrating what actions can be taken using the described batches. In various embodiments, a target directory description is included at 228. The target directory description may include dynamically updating information regarding the current target directory based on a target selected in a navigator menu. One or more of the batches may be selected using the radio buttons or other means on the left side of user interface 200. After selections, a user may utilize the load/redeploy or load/undeploy buttons 230 to take deployment actions.

A user may also use the browse button 232 to search for and locate content that the user would like to add to the media deployer 220 in some embodiments. For example, when a user is uploading content directly from their PC or local machine, or some other local medium connected to their machine, the browse button may be used to locate this content. In various embodiments, a list of the files to be uploaded may appear at 234 and an upload now button 236 may be operative to initiate the uploading of the selected files. It should be understood that while a limited number and arrangement of information is presented in user interface 200 for purposes of illustration, any suitable number, type or arrangement of information could be used and still fall within the described embodiments.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

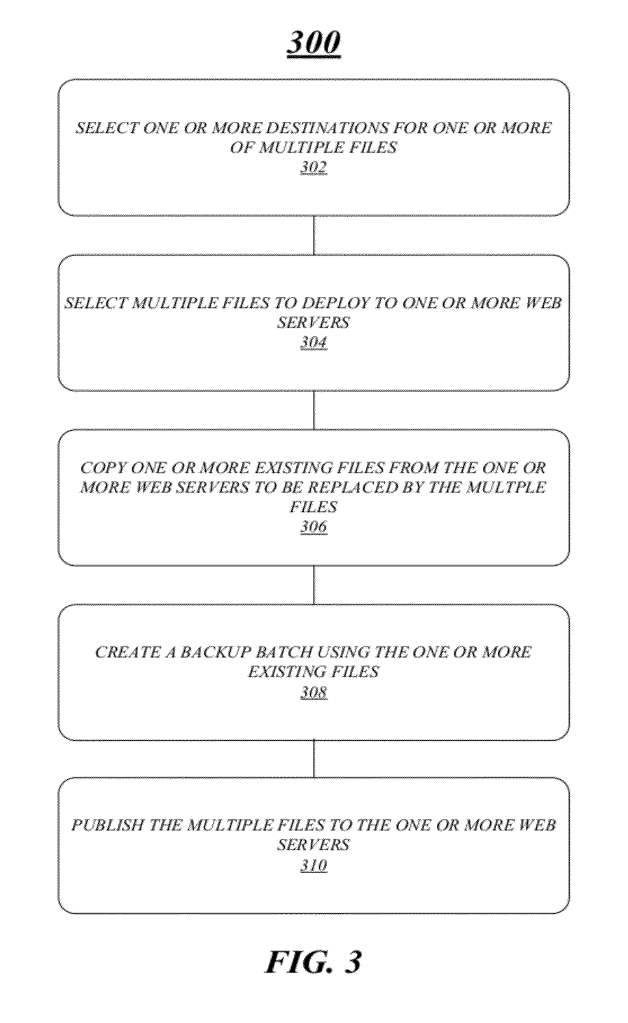

FIG. 3 illustrates one embodiment of a logic flow 300. The logic flow 300 may be representative of some or all of the operations executed by one or more embodiments described herein. In the illustrated embodiment shown in FIG. 3, the logic flow 300 includes selecting one or more destinations for one or more multiple files at block 302. For example, a user may select a same or different destination for each of the multiple files or for any number of the multiple files. In various embodiments, a “target directory” must first be selected before any files are selected. In this manner, a server can log where to place the selected files when a user selects or uploads the files.

The logic flow 300 may include selecting multiple files to deploy to one or more web servers at block 304. For example, a user of client system 110 may access deployer component 120 and may select multiple files to deploy to one or more of server system 130 or web servers 140-1-n. In various embodiments, the multiple files may be selected from one or more of a storage medium on a local device or a storage medium on a remote device. For example, a user may select files to deploy from memory 104-1 of client system 110 or may access files that are already residing on a web server 140-1-n or on server system 130. In various embodiments, a user may select multiple files that comprise new content to be deployed or may select existing content to be redeployed.

At 306, the logic flow 300 includes copying one or more existing files from the one or more web servers to be replaced by the multiple files. For example, in some embodiments a history of all files and batches deployed to the one or more web servers may be maintained and a backup batch may be created using the one or more existing files at 308 of logic flow 300. In various embodiments, this backup batch may be used to ensure the ability to roll back or undue changes made by deploying new content or otherwise overwriting existing files. The batches may be saved in any number of locations, including locally on a users machine or on any one or more remote servers. The embodiments are not limited in this respect.

In some embodiments, the logic flow 300 may include publishing the multiple files to the one or more web servers at 310. In various embodiments, the web servers are operative to deliver content to one or more web pages, wherein the content includes one or more of Hypertext Markup Language (HTML) files that are transferred over the Internet via the Hypertext Transfer Protocol (HTTP), data files, image files or style sheets. For example, after selecting the multiple files and choosing a destination for the files, the files may be published to one or more of web servers 140-1-n where the content may be made live on a website. In various embodiments, a new batch may be created using the multiple files and the new batch and the backup batch may be saved on one or more servers. For example, each deployment of files by a user may include a grouping of the selecting files into a batch. In some embodiments, a batch may include or comprise a grouping of files wherein the grouping is maintained regardless of the destination of the files in the grouping. For example, multiple files may be selected and may be destined for different locations or different web servers. These files, selected and deployed together, may be grouped together into a batch to easily undeploy the entire group of files or to make changes to the group of files as a whole. Other embodiments are described and claimed.

In various embodiments, the multiple files comprising the new batch or any other batch may be undeployed. For example, the undeploying may comprise a redeploying of the one or more existing files from the backup batch to overwrite the multiple files. In this manner, wholesale changes can be made on groups of files without having to locate and change each file individually. Rather, the entire batch can be accessed, modified or edited as necessary and redeployed.

User authentication may be required prior to uploading, viewing, editing or publishing multiple files or altering or interacting with batches in some embodiments. For example, a user may be required to log in to the deployer component tool to make changes. By requiring user authentication, administrators or other authorized personal can limit or restrict the types, location, size or other criteria of content with which users are allowed to interact. In some embodiments, the deployer component may also include the ability to possess another user using administrating authentication to upload, view, edit or publish files from one or more batches created by the other user. In this manner, administrators or other users can gain access to batches created or edited by other users. Other embodiments are described and claimed.

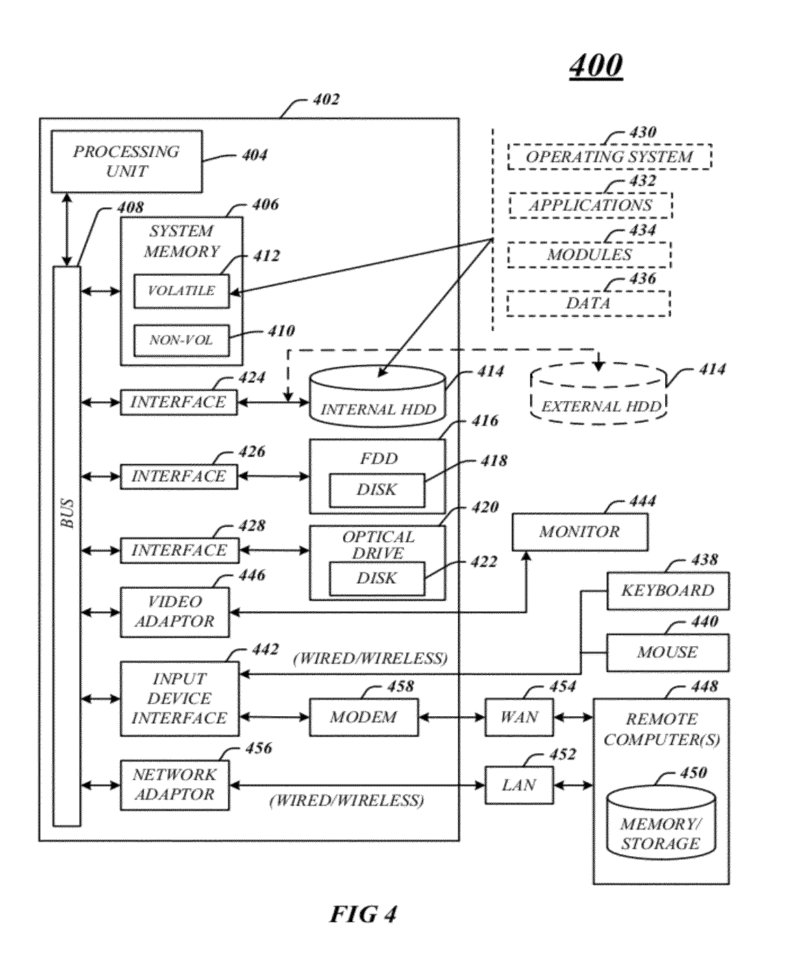

FIG. 4 illustrates an embodiment of an exemplary computing architecture 400 suitable for implementing various embodiments as previously described. The computing architecture 400 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 400.

As shown in FIG. 4, the computing architecture 400 comprises a processing unit 404, a system memory 406 and a system bus 408. The processing unit 404 can be any of various commercially available processors. Dual microprocessors and other multi-processor architectures may also be employed as the processing unit 404. The system bus 408 provides an interface for system components including, but not limited to, the system memory 406 to the processing unit 404. The system bus 408 can be any of several types of bus structure that may further interconnect to a memory bus (with or without a memory controller), a peripheral bus, and a local bus using any of a variety of commercially available bus architectures.

The system memory 406 may include various types of memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 4, the system memory 406 can include non-volatile memory 410 and/or volatile memory 412. A basic input/output system (BIOS) can be stored in the non-volatile memory 410.

The computer 402 may include various types of computer-readable storage media, including an internal hard disk drive (HDD) 414, a magnetic floppy disk drive (FDD) 416 to read from or write to a removable magnetic disk 418, and an optical disk drive 420 to read from or write to a removable optical disk 422 (e.g., a CD-ROM or DVD). The HDD 414, FDD 416 and optical disk drive 420 can be connected to the system bus 408 by a HDD interface 424, an FDD interface 426 and an optical drive interface 428, respectively. The HDD interface 424 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 410, 412, including an operating system 430, one or more application programs 432, other program modules 434, and program data 436. The one or more application programs 432, other program modules 434, and program data 436 can include, for example, the deployer component 120 of FIG. 1.

A user can enter commands and information into the computer 402 through one or more wire/wireless input devices, for example, a keyboard 438 and a pointing device, such as a mouse 440. Other input devices may include a microphone, an infra-red (IR) remote control, a joystick, a game pad, a stylus pen, touch screen, or the like. These and other input devices are often connected to the processing unit 404 through an input device interface 442 that is coupled to the system bus 408, but can be connected by other interfaces such as a parallel port, IEEE 1394 serial port, a game port, a USB port, an IR interface, and so forth.

A monitor 444 or other type of display device is also connected to the system bus 408 via an interface, such as a video adaptor 446. In addition to the monitor 444, a computer typically includes other peripheral output devices, such as speakers, printers, and so forth.

The computer 402 may operate in a networked environment using logical connections via wire and/or wireless communications to one or more remote computers, such as a remote computer 448. The remote computer 448 can be a workstation, a server computer, a router, a personal computer, portable computer, microprocessor-based entertainment appliance, a peer device or other common network node, and typically includes many or all of the elements described relative to the computer 402, although, for purposes of brevity, only a memory/storage device 450 is illustrated. The logical connections depicted include wire/wireless connectivity to a local area network (LAN) 452 and/or larger networks, for example, a wide area network (WAN) 454. Such LAN and WAN networking environments are commonplace in offices and companies, and facilitate enterprise-wide computer networks, such as intranets, all of which may connect to a global communications network, for example, the Internet.

When used in a LAN networking environment, the computer 402 is connected to the LAN 452 through a wire and/or wireless communication network interface or adaptor 456. The adaptor 456 can facilitate wire and/or wireless communications to the LAN 452, which may also include a wireless access point disposed thereon for communicating with the wireless functionality of the adaptor 456.

When used in a WAN networking environment, the computer 402 can include a modem 458, or is connected to a communications server on the WAN 454, or has other means for establishing communications over the WAN 454, such as by way of the Internet. The modem 458, which can be internal or external and a wire and/or wireless device, connects to the system bus 408 via the input device interface 442. In a networked environment, program modules depicted relative to the computer 402, or portions thereof, can be stored in the remote memory/storage device 450. It will be appreciated that the network connections shown are exemplary and other means of establishing a communications link between the computers can be used.

The computer 402 is operable to communicate with wire and wireless devices or entities using the IEEE 802 family of standards, such as wireless devices operatively disposed in wireless communication (e.g., IEEE 802.7 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.7x (a, b, g, etc.) to provide secure, reliable, fast wireless connectivity. A Wi-Fi network can be used to connect computers to each other, to the Internet, and to wire networks (which use IEEE 802.3-related media and functions).

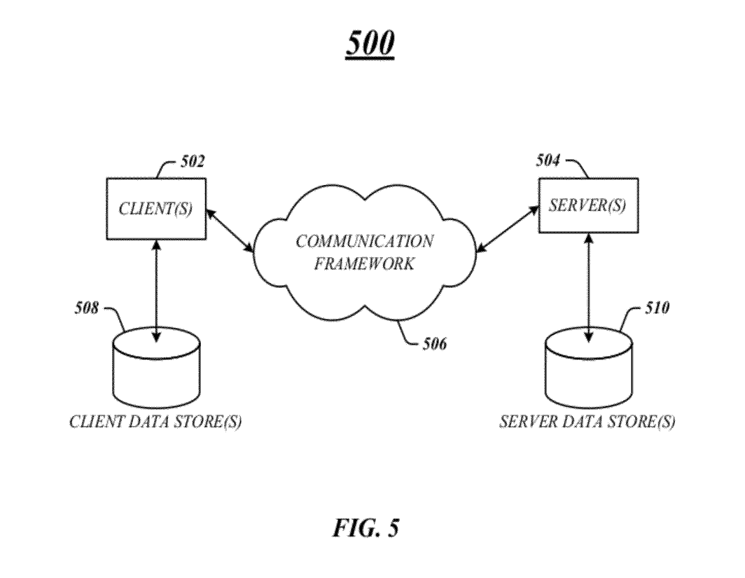

FIG. 5 illustrates a block diagram of an exemplary communications architecture 500 suitable for implementing various embodiments as previously described. The communications architecture 500 includes various common communications elements, such as a transmitter, receiver, transceiver, radio, network interface, baseband processor, antenna, amplifiers, filters, and so forth. The embodiments, however, are not limited to implementation by the communications architecture 500.

As shown in FIG. 5, the communications architecture 500 comprises one or more clients 502 and servers 504. The clients 502 may implement the client systems 110. The servers 504 may implement the server system 330 and 340-1-n. The clients 502 and the servers 504 are operatively connected to one or more respective client data stores 508 and server data stores 510 that can be employed to store information local to the respective clients 502 and servers 504, such as cookies and/or associated contextual information.

The clients 502 and the servers 504 may communicate information between each other using a communication framework 506. The communications framework 506 may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The clients 502 and the servers 504 may include various types of standard communication elements designed to be interoperable with the communications framework 506, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between a client 502 and a server 504 can be in the form of a data packet adapted to be transmitted between two or more computer processes. The data packet may include a cookie and/or associated contextual information, for example.

Various embodiments may be implemented using hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. In various embodiments, the storage medium may include a non-transitory storage medium. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method, comprising:
selecting multiple files to deploy to one or more web servers;
selecting one or more destinations for the one or more multiple files;
copying one or more existing files from the one or more web servers to be replaced by the multiple files;
creating a backup batch using the one or more existing files; and
publishing the multiple files to the one or more web servers.

2. The computer-implemented method of claim 1, comprising:
selecting the multiple files from one or more of a storage medium on a local device or a storage medium on a remote device.

3. The computer-implemented method of claim 1, wherein selecting multiple files comprises selecting new content to be deployed or selecting existing content to be redeployed.

4. The computer-implemented method of claim 1, comprising:
creating a new batch using the multiple files; and
saving the new batch and the backup batch on one or more servers.

5. The computer-implemented method of claim 1, comprising:
maintaining a history of all files and batches deployed to the one or more web servers.

6. The computer-implemented method of claim 1, wherein the one or more destinations comprise different destinations for one or more of the multiple files.

7. The computer-implemented method of claim 1, comprising:
undeploying the multiple files, wherein the undeploying comprises redeploying the one or more existing files from the backup batch to overwrite the multiple files.

8. The computer-implemented method of claim 1, wherein the one or more web servers are operative to deliver content to one or more web pages, wherein the content includes one or more of Hypertext Markup Language (HTML) files that are transferred via a Hypertext Transfer Protocol (HTTP), data files, image files or style sheets.

9. The computer-implemented method of claim 1, comprising:
receiving user authentication prior to uploading, viewing, editing or publishing the multiple files.

10. The computer-implemented method of claim 1, comprising:
possessing another user using administrating authentication to upload, view, edit or publish files from one or more batches created by the other user.

11. An article comprising a store medium containing instructions that if executed by a processor enable a system to:
select multiple files to deploy to one or more web servers;
select one or more destinations for the one or more multiple files;
copy one or more existing files from the one or more web servers to be replaced by the multiple files;
create a backup batch using the one or more existing files;
create a new batch using the multiple files;
save the new batch and the backup batch on one or more servers; and
publish the multiple files of the new batch to the one or more web servers, overwriting the existing files.

12. The article of claim 11, further comprising instructions that if executed enable the system to:
select the multiple files from one or more of a storage medium on a local device or a storage medium on a remote device.

13. The article of claim 11, wherein selecting multiple files comprises selecting new content to be deployed or selecting existing content to be redeployed.

14. The article of claim 11, further comprising instructions that if executed enable the system to:
maintain a history of all files and batches deployed to the one or more web servers.

15. The article of claim 11, wherein the one or more destinations comprise different destinations for one or more of the multiple files.

16. The article of claim 11, further comprising instructions that if executed enable the system to:
undeploy the multiple files, wherein the undeploying comprises redeploying the one or more existing files from the backup batch to overwrite the multiple files.

17. The article of claim 11, further comprising instructions that if executed enable the system to:
receive user authentication prior to uploading, viewing, editing or publishing the multiple files.

18. The article of claim 11, further comprising instructions that if executed enable the system to:
possess another user using administrating authentication to upload, view, edit or publish files from one or more batches created by the other user.

19. An apparatus, comprising:
one or more processors;
a memory communicatively coupled to the one or more processors; and
a deployer component operative to deploy and undeploy multiple files to and from web servers, wherein the multiple files are stored as batches and backups of each batch are stored on one or more servers.

20. The apparatus of claim 19, the deployer component operative to:
select multiple files to deploy to the one or more web servers;
select one or more destinations for the one or more multiple files;
copy one or more existing files from the one or more web servers to be replaced by the multiple files;
create a backup batch using the one or more existing files;
create a new batch using the multiple files;
save the new batch and the backup batch on one or more servers; and
publish the multiple files of the new batch to the one or more web servers, overwriting the existing files.

21. The apparatus of claim 20, the deployer component operative to:
select the multiple files from one or more of the memory of the apparatus or a storage medium on a remote device; and
maintain a history of all files and batches deployed to the one or more web servers.

22. The apparatus of claim 20, wherein selecting multiple files comprises selecting new content to be deployed or selecting existing content to be redeployed and wherein the one or more destinations comprise different destinations for one or more of the multiple files.

23. The apparatus of claim 20, the deployer component operative to:
undeploy the multiple files, wherein the undeploying comprises redeploying the one or more existing files from the backup batch to overwrite the multiple files.

24. The apparatus of claim 20, the deployer component operative to:
receive user authentication prior to uploading, viewing, editing or publishing the multiple files.

25. The apparatus of claim 20, the deployer component operative to:
possess another user using administrating authentication to upload, view, edit or publish files from one or more batches created by the other user.
